(19) United States
(12) Patent Application Publication
(10) Pub. No.: US 2019/0040343 A1
(43) Pub. Date: Feb. 7, 2019

(54) SYSTEM AND METHOD FOR BUILDING A HIGH DENSITY FERMENTED BEVERAGE

(71) Applicant: Pat's Backcountry Beverages, Inc., Wheat Ridge, CO (US)

(72) Inventor: Patrick J. Tatera, Talkeetna, AK (US)

(21) Appl. No.: 15/668,588

(22) Filed: Aug. 3, 2017

(51) Int. Cl. C12C 11/00; C12C 13/00

(52) U.S. Cl. CPC C12C 11/00; C12C 13/00

(57) ABSTRACT

The present invention concerns systems and methods for building a high-density fermented beverage, including a method for building a high-density fermented beverage, the method comprising performing a fermentation process on fermentation ingredients to form a fermented solution in a fermentation vessel; and removing alcohol, aromatics, and/or water from the fermented solution, wherein the removal comprises positioning a membrane intake in a region of lower yeast density the fermentation vessel; removing a first portion of the fermented solution from the fermentation vessel using the membrane intake; and removing alcohol, aromatics, and/or water from the first portion of the fermented solution.

### CROSS-REFERENCE TO RELATED APPLICATION

This application incorporates by reference commonly owned and assigned U.S. Pat. No. 8,889,201, including particularly the description of systems and methods for a nested approach to building a high density beverage that is contained therein.

### FIELD OF THE INVENTION

The present invention relates to beverage production, and particularly systems and methods for making fermented beverages such as beer, wine, alcohol-based ciders, spirits, Kombucha, and the like.

### BACKGROUND OF THE INVENTION

Fermented beverages such as beer, wine, cider, spirits, Kombucha, and the like are enjoyed by people of all classes and across many cultures.

Many of these beverages, however, have high water content by volume. This high water content can increase transportation costs and/or increase the difficulty of enjoying these beverages during outdoor activities like hiking trips or camping.

In order to address the issues of high water content, some manufacturers have turned to prior art solutions of making concentrated beverages. In particular, the industry has focused on prior art solutions of deconstructing the beer, such as removing water before shipping, and then reconstituting the beverage at its destination to reach the desired concentration. For example, multiple old and recent disclosures (e.g., Schutter et al., WO2016083482 A1, “Beer or cider concentrate,” (Anheuser-Busch Inbev S.A.); Peterson et al., US 2016/0230133, “Alcoholic Beverage Concentrate Process,” (Keurig Green Mountain, Inc.); Thijssen, U.S. Pat. No. 4,265,920, “Process for concentration of alcoholic beverages,” (Douwe Egberts); Tokuda et al., US 2008/0063749, “Mead making method”; etc.) focus on a deconstructional approach, where the fermented beverage is processed after it has been brewed to completion, and it is broken down into separate components. Using this deconstructional approach, a fermented beverage such as beer can be processed through a membrane separation step to separate it into a permeate stream (substantially comprising water, aroma, and alcohol), and a retinate stream (substantially comprising beer flavoring components, aroma, alcohol, and some water). In certain instances, the permeate stream is then processed further to remove alcohol and aromatics from the permeate so that they can be returned to the retinate. This further processing of the permeate stream is typically done using processes such as freeze concentration or distillation. There are many problems with a deconstructional approach. The process requires that the fermented beverage be brewed completely (or near completely) in advance of the concentration processing, thus the concentration processing becomes an added set of steps to the brewing process. This adds time and hence reduces production capacity. In addition, the added equipment costs in deconstructional approaches can be substantial (e.g., distillation and freeze concentration equipment), and it may require specialized permits (distillation permits) depending on the brewing location. Moreover, deconstructional approaches also open up a potentially damaging processing activity (post fermentation) that can expose the fragile finished beer to the effects of damaging oxidation, and therefore reduce shelf stability of the finished product.

In order to address some of the problems with the prior art, one recent inventive approach is to use a nested fermentation process to build a higher concentrate beverage. For example, in U.S. Pat. No. 8,889,201 the present applicant taught inventive systems and methods for nested fermentation. In contrast to the deconstructional approach, the nested fermentation process is a constructional approach where the finished high density fermented beverage is a result of building the final level of flavor concentration through one or more additive steps. This is advantageous because it reduces the necessary residence time of the beverage within the fermentation vessel, relative to the amount of servable product produced, therefore increasing the production capacity of the equipment, which is a further asset to the brewer. Thus, the high density fermented beverage is an outcome of construction, rather than deconstruction and re-assembly. For example, one of the benefits of the nested fermentation process is that it can mitigate sequential fermentation lag phases by removing alcohol and adding new fermentation ingredients shortly after peak metabolic rate has been achieved. Thus, multiple batches of fermentation ingredients can be metabolized without requiring additional lag-phase or conditioning time investment. Another benefit of a nested approach is that it allows the high density beverage to finish in the same stable oxidative state as with traditional, non-concentrated approaches. The high density beverage will then degrade at the same rate as traditionally produced fermented beverages. However, because the high density beverage is diluted for serving, the degradative flavors are also diluted. Thus the beverage can exist in its high density form for a longer time than traditional, non-concentrated beverages before degradative effects reach unacceptable flavor threshold levels in the finished beverage.

Accordingly, it is desirable to have further innovations and advancements for systems and methods of building high density beverages, such as high density beer, wine, ciders, spirits, or the like. For example, in one embodiment, U.S. Pat. No. 8,889,201 teaches the use of reverse osmosis (membrane technology) as a separation technique applicable to the nested fermentation process. The benefits of applying reverse osmosis for supporting the nested fermentation process are significant, but require specialized processing considerations in order to optimize these benefits. The present application identifies previously undiscovered issues with membrane separation technologies for nested fermentation, and presents novel and inventive solutions to these issues.

### SUMMARY OF THE INVENTION

In one embodiment, the present invention is a method for building a high-density fermented beverage comprising: performing a fermentation process on fermentation ingredients to form a fermented solution in a fermentation vessel (such as a fermentation tank), and removing alcohol, aromatics, and/or water from the fermented solution, wherein the removal comprises: positioning a membrane intake in a region of lower yeast density the fermentation vessel, and removing a first portion of the fermented solution from the fermentation vessel using the membrane intake; and removing alcohol, aromatics, and/or water from the first portion of the fermented solution. This method may further comprise separating alcohol, aromatics, and/or water from the first portion of the fermented solution thereby creating a retinate and a permeate; positioning a retinate return in the fermentation vessel, and returning at least a portion of the retinate to the fermentation vessel using the retinate return. The membrane intake can be positioned below a top fermentation region for a top fermenting yeast and/or positioned above a yeast settling region. The retinate return can be positioned below a top fermentation region for a top fermenting yeast, between membrane intake and the top fermentation region, and/or below the membrane intake and above a yeast settling area. Moreover, the retinate return can be positioned to reduce turbidity. The removal process in this method may comprise performing a yeast removal process on the first portion of the fermented solution; and performing a membrane process on the first portion of the fermented solution after the yeast removal process to separate out alcohol, aromatics, and/or water.

In another embodiment, the present invention comprises a system for building a high-density fermented beverage, the system comprising: a fermentation vessel, a membrane system connected to the fermentation vessel; a membrane intake that provides an input to the membrane system from the fermentation vessel, wherein the membrane intake is positioned in a region of lower yeast density; and a retinate return that provides an input to the fermentation vessel from the membrane system. The membrane intake may be positioned below a top fermentation region for a top fermenting yeast, and/or above a yeast settling region. The retinate return can be positioned below the top fermentation region, between the membrane intake and the top fermentation region, and/or below the membrane intake and above a yeast settling area. The retinate return may comprises one retinate return port or multiple retinate return ports into the fermentation tank. Similarly, the membrane intake may comprise one or more membrane intake ports. For a bottom fermenting yeast, the membrane intake may be positioned above a bottom fermentation region. Both the membrane intake the retinate return can be fixed in a single position or adjustably positionable.

In another embodiment, the present invention includes a method for building a high-density fermented beverage, the method comprising: performing a fermentation process on fermentation ingredients to form a fermented solution in a fermentation vessel; removing alcohol, aromatics, and/or water from the fermented solution using a membrane process to generate an intermediate solution, wherein the removal comprises: removing a portion of the fermented solution from the fermentation vessel; performing a yeast removal process on the portion of the fermented solution; performing the membrane process on the portion of the fermented solution after the yeast removal process; adding additional fermentation ingredients to the intermediate solution; and performing an additional fermentation process on the additional fermentation ingredients in the intermediate solution. The yeast removal process may comprise a centrifugal process and/or other yeast removal processes.

In another embodiment, the present invention is a system for building a high-density fermented beverage, the system comprising: a fermentation vessel; a membrane system connected to the fermentation vessel; and a yeast removal system connected between the fermentation vessel and the membrane system.

In yet another embodiment, the present invention includes a method for building a high-density fermented beverage, the method comprising: performing a fermentation process on fermentation ingredients to form a fermented solution; removing alcohol, aromatics, and/or water from the fermented solution using a membrane process to generate an intermediate solution; adding additional fermentation ingredients to the intermediate solution; performing an additional fermentation process on the additional fermentation ingredients in the intermediate solution; and adding hop extract to the intermediate solution during the additional fermentation process.

In another embodiment, the present invention includes method for building a high-density fermented beverage, the method comprising: performing a fermentation process on fermentation ingredients to form a fermented solution; removing alcohol, aromatics, and/or water from the fermented solution using a membrane process to generate an intermediate solution; adding additional fermentation ingredients to the intermediate solution; performing an additional fermentation process on the additional fermentation ingredients in the intermediate solution; and adding kettle extract to the intermediate solution during the additional fermentation process. Adding the kettle extract may comprise: mixing the kettle extract into an aqueous solution to create an aqueous-kettle-extract mixture; and then adding the aqueous-kettle-extract mixture to the intermediate solution during the additional fermentation process. In addition, adding the kettle extract may comprise adding PIKE, where in some embodiments adding the PIKE comprises: creating a mixture of PIKE, alcohol, and wort solution; heating the mixture of PIKE, alcohol, and wort until at least a portion of the alcohol evaporates to generate a wort-PIKE mixture; and adding the wort-PIKE mixture to the intermediate solution during the additional fermentation process.

In yet another embodiment, the invention comprises a method for building a high-density fermented beverage, the method comprising: performing a fermentation process on fermentation ingredients to form a fermented solution; removing alcohol, aromatics, and/or water from the fermented solution using a membrane process to generate an intermediate solution; adding additional fermentation ingredients to the intermediate solution; performing an additional fermentation process on the additional fermentation ingredients in the intermediate solution; and adding a vegetative-hops-solution to the intermediate solution during the additional fermentation process. Adding the vegetative-hops-and-wort-solution may include: adding vegetative hops during a kettle boil of the wort to form the vegetative-hops-and-wort-solution; and adding the vegetative-hops-and-wort-solution to the intermediate solution during the additional fermentation process. Adding the vegetative-hops-and-wort-solution may also comprise adding vegetative hops to an initial wort; and boiling the initial wort to introduce isomerized bittering acids from the vegetative hops into the wort to generate an intermediate wort; removing the vegetative hops from the intermediate wort; concentrating the intermediate wort to form the vegetative-hops-and-wort-solution, and adding the vegetative-hops-and-wort-solution to the intermediate solution during the additional fermentation process.

In a further embodiment the invention comprises a method for building a high-density fermented beverage, the method comprising: performing a fermentation process on fermentation ingredients to form a fermented solution; generating an intermediate solution comprising: performing a membrane process on the fermented solution to remove alcohol, aromatics, and water; and adding additional fermentation ingredients during the membrane process, wherein the rate of the membrane process and the rate of adding additional fermentation ingredients are balanced in order to control the osmotic pressure of the fermented solution; performing an additional fermentation process on the intermediate solution.

In another embodiment the invention may comprise a method for controlling osmotic pressure during nested fermentation, the method comprising: performing a nested fermentation process to generate a dry fermented solution; adding additional fermentation ingredients to the dry fermented solution; performing an additional fermentation process on the additional fermentation ingredients in the dry fermented solution; and adding maltodextrin during the additional fermentation process.

In an additional embodiment the invention is a method for controlling osmotic pressure during nested fermentation, the method comprising: performing a nested fermentation process to generate a dry fermented solution; adding additional fermentation ingredients to the dry fermented solution, wherein the additional fermentation ingredients include a wort with increased unfermentable sugars and starches; and performing an additional fermentation process on the additional fermentation ingredients in the dry fermented solution.

In yet a further embodiment, the present invention is a system for building a high-density fermented beverage comprising a kettle including an exit path and a return path; and a first hops tank, wherein an input to the first hops tank is connected to the exit path of the kettle and an output of the first hops tank is connected to the return path of the kettle. The system may include additional hops tank, such as a second hops tank, wherein an input to the second hops tank is connected to the exit path of the kettle and an output of the second hops tank is connected to the return path of the kettle; a third hops tank, wherein an input to the third hops tank is connected to the exit path of the kettle and an output of the third hops tank is connected to the return path of the kettle; and a fourth hops tank, wherein an input to the fourth hops tank is connected to the exit path of the kettle and an output of the fourth hops tank is connected to the return path of the kettle. In order to add different types of hops additions to the beverage, the first hops tank may be a bittering hops tank, the second hops tank a flavoring hops tank, and the third and fourth hops tanks aroma hops tanks. The hops tanks may be configured such that liquid exiting the kettle through the exit path can pass through zero, one, two, three, or all of the hops tanks before returning to the kettle through the return path.

In yet an additional embodiment, the present invention includes a method for building a fermented beverage, the method comprising: boiling wort in a kettle to form a first solution; during a first time period, passing at least a portion of the first solution through a first hops tank and back into the kettle to form a second solution; during a second time period, passing at least a portion of the second solution through a second hops tank and back into the kettle to form a third solution; and during a third time period, passing at least a portion of the third solution through a third hops tank and back into the kettle to form a fourth solution. During the second, third, and fourth time periods, the solution can be passed through one or multiple hops tanks. For example, during the second time period the second solution can be passed through both the first hops tank and the second hops tank, and during the third time period the third solution can passed through both the first hops tank, the second hops tank, and the third hops tank. Each hops tank can include different hops. For example, the first hops tank may contain bittering hops, the second hops tank may contain flavoring hops, and the third hops tank may contain aroma hops. The method may include a fourth time period, that includes passing at least a portion of the fourth solution through a fourth hops tank and back into the kettle to form a fifth solution. During the first, second, and third time periods the solution in the kettle may be kept at a boiling temperature, while during the fourth time period, it may be advantageous (e.g., for adding final aroma hops) to reduce the temperature of the fourth solution so that the fourth solution is not boiling and then passing the portion of the fourth solution through the fourth hops tank and back into the kettle to form the fifth solution. Of course, the final aroma hops could be added during an earlier time period and the temperature reduced during that period.

### BRIEF DESCRIPTION OF THE FIGURES

The invention is more fully appreciated in connection with the following detailed description taken in conjunction with the accompanying drawings, in which:

FIG. 1 provides an exemplary embodiment of a fermentation vessel that is using a top fermenting yeast consistent with the present invention;

FIGS. 2A and 2B provide exemplary embodiments of a fermentation vessel that is using a bottom fermenting yeast consistent with the present invention;

FIG. 3 provides an exemplary embodiment of the use of a yeast removal system to remove yeast prior to a membrane system;

FIG. 4 provides an exemplary embodiment of the use of multiple external hop tanks with the kettle;

FIG. 5 provides an exemplary embodiment of the use of a single external hop tank with the kettle;

FIG. 6 provides an exemplary embodiment of the use of an external hop tank with the fermentation vessel.

Like reference numerals refer to corresponding parts throughout the several views of the drawings.

### DETAILED DESCRIPTION OF THE INVENTION

In U.S. Pat. No. 8,889,201, and related applications, the present applicant introduced an inventive approach to building a high density beverage. The description in U.S. Pat. No. 8,889,201, including particularly the description of the nested approach to building a high density beverage, is incorporated herein by reference.

One advantage to using reverse osmosis to support the nested fermentation process is that it supports the ability to maintain active yeast metabolism throughout the process. Vacuum and heat distillation techniques do not support active fermentation in this same way, as substantial heat kills yeast cells, and vacuum conditions can rupture yeast cells resulting in off-flavors to the fermented beverage. Other membrane separation/concentration processes require that a finished beverage be processed through the membrane. These techniques substantially result in concentrated beverages with a reduced shelf stability caused by oxygen ingress during processing. This effect is not always readily detectable upon completion of producing the concentrated beverage, but presents itself within the timing of oxidation effects after having entered the supply chain in many cases.

Keeping fermentation active throughout processing helps to avoid any negative oxidation effects to the fermented beverage. Yeast are an effective scavenger for oxygen, and quickly metabolize available oxygen when they are metabolically active. The process of dealcoholizing beer can result in exposing the beer to ambient oxygen, thus accelerating the oxidative degradation of the beer. By conducting the removal of alcohol while still under active fermentation, the brewer can be assured that any ingress of oxygen to the beer will be metabolized by the fermenting yeast. Oxygen is a necessary nutrient of yeast, and its availability can support healthy yeast function and metabolism, including promoting yeast cell wall structure. Thus, while the present invention seeks to avoid negative oxidation effects, it is noted that some oxygen ingress is acceptable during processing of the actively fermenting beverage of the present invention because it is readily metabolized in the presence of active/functioning yeast.

Controlling Yeast

In certain embodiments of the present invention, it has been discovered that it is desirable to reduce the amount and size of yeast material that travels through the membrane equipment when processing the fermenting beverage through a membrane system (e.g., a system, such as a reverse-osmosis membrane system or nano-filtration membrane, that uses a semipermeable membrane to separate an aqueous solution). Reducing the yeast material that travels through the membrane equipment can be beneficial for many reasons, including reducing clogging (or fouling) of the membrane and pre-filter components of the system. Yeast material—and particularly larger high-density yeast particles that consist of multiple bound/bundled yeast cells such as floctuated yeast particles, sedimented yeast particles, coalesced yeast particles, or congregated yeast particles—can cause problematic impacts on membrane equipment.

Thus, in certain embodiments, the fermentation vessel (the vessel where fermentation takes place, such as a fermentation tank, sometimes referred to as a fermenter or fermentor) and membrane system in the present invention are designed in order to reduce the amount of yeast material, including high-density yeast material that is passed through the membrane system. This includes designing the intake to the membrane system so that it is positioned (and/or positionable) to pull from a region of the fermentation vessel that has lower levels of yeast material and particularly, lower levels of high-density yeast material. In addition, it can include designing the retinate return to the fermentation vessel in order to reduce turbidity and better control the resident location of (high-density) yeast material in the fermentation vessel.

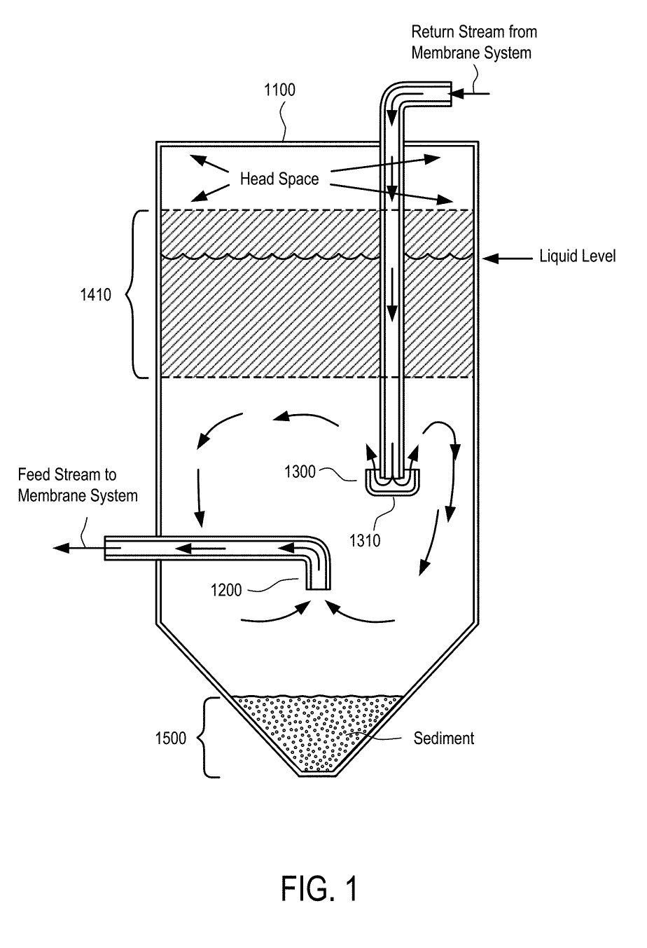

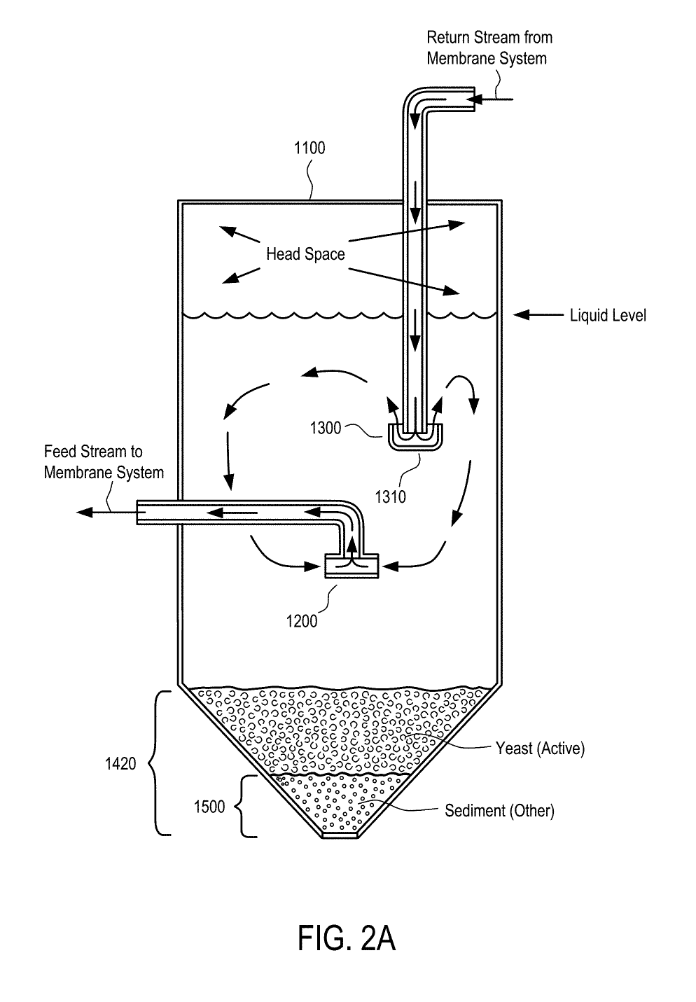

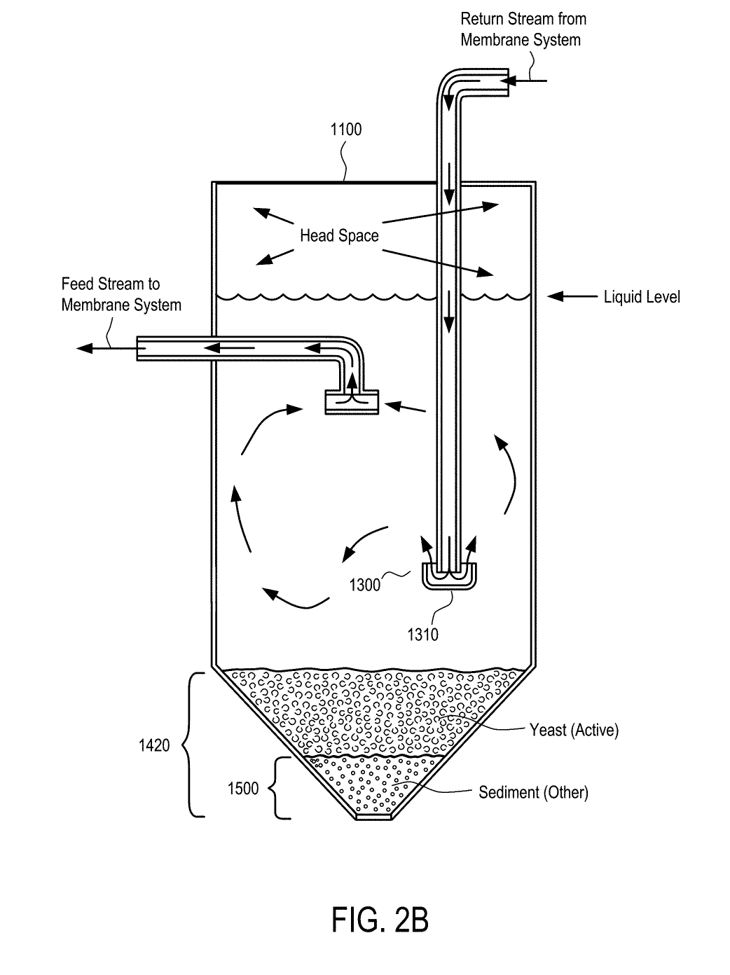

Designing the intake to the membrane system in order to pull from a region of the fermentation vessel that has lower levels of (high-density) yeast material can be impacted by many factors, including the type of fermenter being used, the type of yeast strand, and the type of fermented beverage being produced. For example, brewing yeasts are often broadly categorized as bottom fermenting or top fermenting. FIGS. 1 and 2 show exemplary diagrams for bottom fermenting yeast and top fermenting yeast. As shown in FIG. 1, for a top fermenting yeast, the membrane intake 1200 is positioned in an area of lower yeast density toward the bottom of the fermenter. In preferred embodiments for top fermenting yeast, the membrane intake 1200 is positioned below the top fermentation region 1410 where the highest density of top fermenting yeast are active, but above the settling area 1500 where dead and dormant yeast will settle. Note that in certain embodiments, methods or systems may be used to remove dead and dormant yeast such that the settling area is reduced or eliminated, thereby allowing the membrane intake 1200 to be positioned further down. As will be understood by those of skill in the art, some ambient level of yeast will be present throughout the solution in the fermentation vessel. The fermentation region 1400 refers to the region of increased yeast density based on the type of fermenter being used. In one embodiment, the fermentation region 1400 has a yeast density that is at least twice the ambient level. For the bottom fermenting yeast examples in FIGS. 2A and 2B, the membrane intake 1200 is positioned above the bottom fermentation region 1420 where the highest density of bottom fermenting yeast are active (and where dead or dormant yeast will settle). As will be understood by those of skill in the art, the membrane intake 1200 may be comprised of one or more membrane intake ports. If multiple membrane intake ports are used, preferentially each intake port will be positioned to reduce the amount of yeast pulled into the membrane system.

In addition, a further aspect of present invention is to position the location of the retinate return (from the membrane system) such that it minimizes or avoids the creation of currents within the fermentation vessel that would cause yeast to become stirred up within the fermentation vessel. (It is also noted that the retinate should be delivered to the fermentation vessel at low pressure and low flow rate to reduce turbidity.) Returning to FIGS. 1, 2A, and 2B, exemplary positioning of the retinate return 1300 is provided. For the top fermenting example in FIG. 1, the retinate return 1300 is positioned below top fermentation region 1410. In addition, although not required in all embodiments, in this embodiment the retinate return 1300 is positioned closer to the top fermentation region 1410 than the membrane intake 1200 because this helps to maintain the segregated regions of high-density yeast material. Moreover, the retinate return 1300 should also be positioned far enough away from the membrane intake 1200 that the fermenting liquid will remain uniform throughout processing, and will not build up regions of higher density. This promotes more uniform processing of the fermenting beverage. Note that while a single retinate return location is shown, those of skill in the art will understand that multiple retinate return locations can be used to promote uniform processing and reduce turbidity.

The same principles are applied to the bottom fermenting beverage system in FIGS. 2A and 2B. In each embodiment, the retinate return 1300 is located above the bottom fermentation region 1420. In FIG. 2A, the retinate return 1300 is further located above the membrane intake 1200. However, as shown in FIG. 2B, those of skill in the art will recognize that this is not strictly required and that the retinate return 1300 may be positioned between the membrane intake 1200 and the bottom fermentation region 1420. As previously discussed, one or more retinate returns may be used consistent with the present invention.

In each of FIGS. 1, 2A, and 2B, the retinate return 1300 is shown with an optional redirect cap 1310 that can optionally be used to help control current flow through the fermentation vessel, help reduce turbidity, and better control the resident location of (high-density) yeast material. In addition, each figure shows that the membrane intake 1200 is configured to draw from multiple directions within the fermentation vessel to help with current flow, turbidity, and controlling yeast location. Those of skill in the art will appreciate that there are numerous variations that can be made to the number of intakes and returns, the position of the intakes and returns, and the configuration of the intakes and returns. FIGS. 1, 2A, and 2B also show the pipe connected to the membrane intake to enter from the side of the fermentation vessel, and the pipe connected to the retinate return to enter from the top of the fermentation vessel. This is non-limiting. The benefits and advantage of the present invention may be achieved regardless of how and where the pipes enter the fermentation vessel. Moreover, the pipes need not enter in different locations. Numerous variations will be understood by those of skill in the art in order to achieve the advantages and benefits taught in the present invention.

In certain embodiments of the invention, the membrane intake 1200 and/or retinate return 1300 may be adjustably positionable. By allowing the positions of the membrane intake 1200 and/or retinate return 1300 to be adjustable, the same system can be used for differing fermenters (e.g., top or bottom fermenting yeast) or other process conditions (e.g., depending on the volume of solution in the fermentation vessel). For example, if the volume of solution in the fermentation vessel is reduced (either during a single process or as compared to other processes), the retinate return 1300 may need to be adjusted lower. In another example, if the fermentation vessel is used first for a top fermenting yeast and then is going to be used for a bottom fermenting yeast, the membrane intake may need to be raised. In one non-limiting example, the length of the retinate return pipe may be adjustable in order to vary the height of the retinate return 1300. Likewise, the fermentation vessel may be designed such that the membrane intake 1200 can be positioned at various heights in the side of the fermentation vessel 1100. (Note that, as discussed above, in other embodiments the membrane intake 1200 may enter from the top or bottom of the fermenter and have an adjustable length pipe, and the retinate return 1300 may enter from the side of the fermentation vessel 1100 and be configured to have an adjustable height.) In certain methods, the membrane intake 1200 and/or the retinate return 1300 can be adjustably positioned based on the process conditions (e.g., fermenter type, volume of the solution, etc.) in order to reduce yeast intake into the membrane system.

It will be understood by those of skill in the art that active yeast and dormant yeast cells will be found throughout the fermentation vessel. The improved design of the membrane intake and retinate return in the present invention will reduce, but may not necessarily completely eliminate, yeast intake to the membrane system. If the density of undesired yeast entering the membrane system is too great—for example if it poses a threat to efficient processing activities—additional embodiments of the present invention use yeast separation tactics to remove yeast from the membrane intake stream before it reaches the membrane system. As will be recognized by those of skill in the art, these yeast separation tactics may be added to, or used separately from, the improved membrane intake and retinate return designs discussed above.

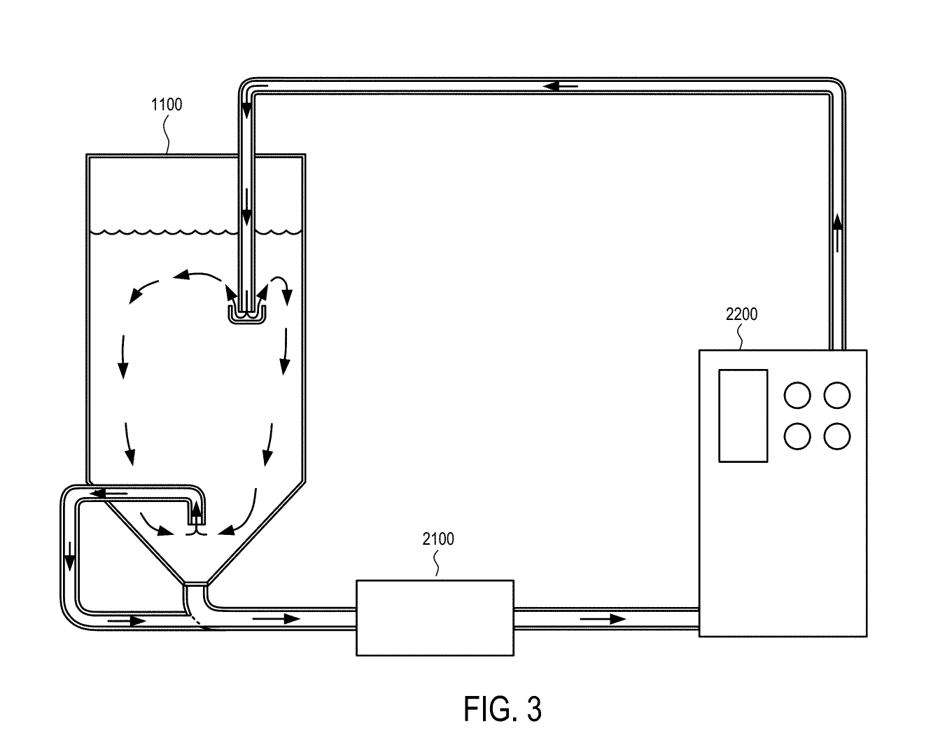

By way of example, FIG. 3 shows one embodiment of the present invention where a yeast removal system 2100 is inserted between the fermentation vessel 1100 and the membrane system 1200. Many yeast removal systems are known to those of skill in the art, including cold crashing, filtration, and centrifuge. All removal systems have inherent limitations, benefits, and drawbacks. For continuous flow processing under active fermentation, a centrifuge is an efficient tool for this means, and can remove high percentages of suspended yeast from the beer stream, while supporting the returning of that yeast back to the fermentation vessel 1100 for continued fermentation function. Thus the active yeast is only removed as needed during the membrane processing pass. Another yeast removal tactic is to sufficiently chill the beer well in advance of processing to cause yeast to fall out of suspension. This results in clarification of the beverage to some extent. In addition, given the potential problems caused by heat introduced to the system, it may be advantageous to cool the stream through the membrane system (and cool the liquid in the fermentation vessel 1100 when the liquid is returned from the membrane system 2200). In other embodiments, however, once membrane processing is complete, the temperature of the retinate may need to be returned to fermenting temperatures (e.g., requiring a heating tank or other configuration to head the liquid that goes from the membrane system 2200 to the fermentation vessel 1100). Filtration can also be used for yeast removal. However, it has been found that if there are large quantities of yeast passing through the filter that the filters will occasionally, and sometimes frequently, clog. Partial or complete clogging is not only likely to require maintenance, it may also negatively impact or waste the beverage being generated. Accordingly, in the present invention it may be preferable to use self-cleaning or multi-stage filters. For example, those of skill in the art will be familiar with self-cleaning filters that have been designed to aid in self-cleaning and back-flushing, and which therefore may reduce the amount of manual cleaning required or the likelihood of clogging during the process of generating the beverage. Other filters, such as multi-stage filter systems, are beneficial because process liquid flow path can be diverted away from a clogged/spent filter and routed through a fresh subsequent filter are another means for mitigating the processing down time otherwise needed for the cleaning of clogged/spent filters. By having fresh subsequent filters always available for the selected diversion of the process liquid, the clogged/spent filter(s) can be isolated, cleaned, and re-purposed while the beverage is still undergoing processing, and thereby made available as a fresh subsequent filter for use during later required flow path diversion of the process liquid. Those of skill in the art will recognize further options consistent with the present invention.

In one embodiment of the present invention, the yeast removal process is used within a nested fermentation process. The yeast removal process can be used to remove yeast from the solution as it passes between the fermentation vessel and the membrane system. The yeast removal can be done after the first fermentation, or subsequent fermentation steps, in a nested fermentation process. For example, in one embodiment fermentation ingredients are fermented in a fermentation vessel to form a fermented solution. The fermented solution could be the result of an initial fermentation step, or it could be the result of one of the intermediate fermentation steps in a nested fermentation process. A portion of the fermented solution is then removed from the fermentation vessel. Depending on the yeast removal process being used, the removal of a portion of the fermented solution could be a continuous process, or a discontinuous process that removes a fixed volume of the fermented solution. After the yeast removal process is performed on the fermented solution, a membrane process is used to remove certain components such as alcohol, aromatics, and/or water from the fermented solution to create an intermediate solution. The intermediate solution refers to the fact that in a nested fermentation process, one or more fermentation steps are performed before fermentation is complete. Typically, the yeast removal process (and membrane process) will be performed after each fermentation step other than the final fermentation step.

As will be understood by those of skill in the art, the use of a yeast removal process/system between the fermentation vessel and the membrane system can be used alone or in combination with the other methods/systems described herein. The present application specifically teaches, encourages, and imagines combining the various methods and systems described herein to achieve maximum benefits. As a non-limiting example, using a yeast removal system as taught herein may be combined with the use of a membrane intake and/or retinate return design as discussed above. Moreover, in this combination additional methods and designs may be allowed. For example, in systems and methods that use the yeast removal system, it may be desirable to position the membrane intake closer to or in the yeast settling area in order to use the yeast removal system to clear out some settled yeast. Additional combinations and variations will be understood by those of skill in the art in view of the overall disclosure herein.

Controlling Hops

In additional embodiments of the present invention, it has been discovered that increased efficiency and improved fermented beverages, and in particular beer, may be created by using new methods for the addition of hops. Hops are used primarily for purposes of adding bittering, flavor, and aroma to a beer. How and when hops are added to the beer define how they impact the beer. For example, typically hops are added to the kettle when the wort is being boiled—either at the beginning of the boil (for bittering) or the end of the boil (for aromas). But the present invention has discovered that for beer that is processed through membrane separation equipment and/or is being brewed in a nested fermentation process, new pathways of introduction, addition, and/or utilization of hops were required in order to protect the beers flavor profile, aid in efficient processing of the beer, and efficiently utilize the hops being added.

Due to the different uses and types of hops in creating a beer, the following description provides embodiments of the present invention for different types of hops. Each of these embodiments is based on a nested fermentation process that uses membrane technology for forming a high-density fermented beverage.

Bittering Hops

In at least some embodiments of the present invention, the method of building a fermented beverage involves controlling the timing and type of bittering hops, as well as other additives that may be included with the addition of the bittering hops, to improve upon the nested fermentation process. Following the approach in the present invention helps prevent complications to the membrane processing that can be caused by certain products of the buttering hops—such as large isomerized bittering acids and aromatic oils that are derived from the addition of the bittering hops.

In addition, following the approach in the present invention helps control the impact of the bittering hops (as the products of the bittering hops) on yeast performance. When managing high concentrations of bittering (and hop oil aromatic) compounds within a specified fermented beverage, it has been found that those compounds can negatively impact the yeasts performance in fermentation pathways. An effect whereby the yeast becomes “coated”, where the sticky hop resins and oils coat the outer cell wall of the yeast cell and hinder its ability to effectively carry out metabolic function. In addition to this destructive effect upon fermentation, the coating also results in a loss of desirable hop compounds to the finished beverage. Because the yeast are ultimately removed after fermentation is complete, any resins/oils that have adhered to the yeast cellular material are also lost.

In order to minimize the negative impacts of coated yeast, one embodiment of the present invention involves the addition of the bittering hops after or coincident with the last membrane step in a nested fermentation process such that bittering molecules are minimized in the membrane processing. By adding the bittering hops at this stage, the present invention is able to achieve the desired flavor profile of using a traditional approach, while gaining the benefits and efficiencies of a nested fermentation approach.

There are several options on how to best add bittering hops to the beverage at this stage. In one embodiment, fully isomerized hop extracts (such as those available on the market) may be used. Fully isomerized hop extracts are typically designed for adjusting the bittering levels (IBUs—International Bittering Units) of the beverage post fermentation. These can be added according to producer recommendations for adding bittering to the beer. However, in taste paneling this option, most of the products available resulted in a chemical or artificial taste. This was particularly true of very bitter beers such as IPAs and other craft beer styles.

In another embodiment, a kettle extract is used. One well known kettle extract product is PIKE (Potassium Isomerized Kettle Extract). Kettle extracts such as PIKE are commonly very viscous and not readably soluble in an aqueous solution, especially at high concentrations as is typical of very bitter beer styles. In a traditional approach, the viscosity of the kettle extract is overcome by adding during the kettle boil where it has a long period of time at high temperatures (boiling) to go into solution of the pre-fermented wort. However, when adding kettle extract to the high density beverage that is formed during nested fermentation, it is ideally added during the final ferment, after all membrane processing takes place (or alternately (but less ideally), during the final membrane processing), and thus there is no lengthy boil time possible for addition to the primary wort supply. Furthermore, because it is desired to add this product during the final ferment of the nested beer, the concentration of the kettle extract is that of multiple densities of beer. For example, if a high-density fermented beverage is nested to a 6 fold level of flavor concentration, the appropriate level of bittering from PIKE would be achieved by adding 6 fold the normal level (relative to what would be added to a single strength flavored beer). This added concentration of kettle extract increases the difficulties of getting the kettle extract adequately into solution.

In order to overcome these difficulties, embodiments of the present invention include additional procedures for adding the kettle extract. As the final fermentation is beginning to slow down, and it becomes evident that the primary fermentation is ending (transitioning to a slower conditioning phase), the necessary kettle extract addition is prepared. Preferentially, the kettle extract is added during the slower conditioning phase so that there is still some residual yeast activity. By adding the kettle extract while some yeast activity is present the remaining active yeast can help prevent negative impacts of any oxygen introduced while the kettle extract is being added. In addition, the convection of the beer under fermentation will help uniformly mix the kettle extract that is to be added.

In addition, to accommodate this late fermentation addition of kettle extract, the brewer can add the kettle extract to a small amount of aqueous solution (and preferably wort) relative to the amount of kettle extract being added. For example, and not in any way limiting the present invention, 4 mL of wort may be used for every 1 gram of PIKE to be added. (Those of skill in the art will realize that many other ratios are consistent with the present invention, such as 3 or 6 mL wort/grams of PIKE.) In order to promote mixture between the aqueous solution (preferably wort) and the kettle extract, the combination may be heated in a separate container before being added to the fermentation vessel. At this stage, the kettle extract will not readily be in solution. In order to further promote solubility, alcohol (such as ethanol) may be added to the aqueous kettle extract mixture. By way of example, but not limitation, 1 mL of ethanol per 1 gram of PIKE may be added and mixed with the aqueous solution (and preferably wort) and PIKE. Then the aqueous kettle extract mixture can be brought to a boil, and held for an appropriate period of time, such that the ethanol evaporates, and any undesired aroma from the kettle extract is evaporated as well. The resultant solution, with the concentrated kettle extract, can then be cooled and added to the fermentation vessel, where the fermented beverage is undergoing its final ferment, and ideally having completed primary fermentation and now in its conditioning phase. The fermentability of the wort will also support the rapid distribution of the kettle extract throughout the finishing beverage, as the wort is metabolized by the active yeast contained within the finishing beer. As noted above, these same PIKE preparation, mixing, and addition steps can also be followed out with another aqueous solution, such as water, as a substitute for wort, however water will not have the added advantage of being fermentable.

In yet another embodiment of the present invention, traditional vegetative hops may be used as the buttering hops. The present invention provides multiple processes for the use of traditional hops. First, in one embodiment the traditional vegetative hops are mixed to the final wort—the wort that is added to the fermenting beverage while alcohol is simultaneously being removed via membrane removal—before the final wort is added. In this embodiment, the traditional hops are preferentially added to the final wort when the final wort undergoes its kettle boil. As with the kettle extract (such as PIKE) usage described above, the quantity of traditional hops to be added at this stage must impart sufficient bittering to the final fermented beverage as to compensate for the high level of density of the beverage due to the nested fermentation and membrane processes. It will be understood by those of skill in the art that adding the traditional hops to the final wort is likely to result in the processing loss of some bittering compounds by the membrane system. Thus the amount of bittering compounds in the final wort should account for losses to the membrane separation process, and losses due to yeast “coating” effects.

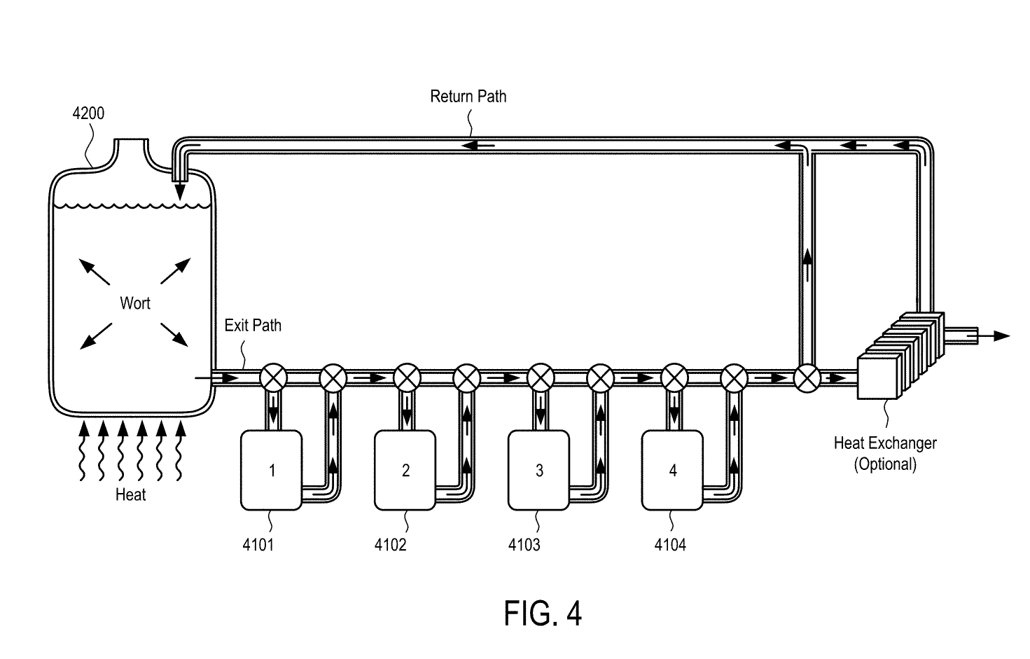

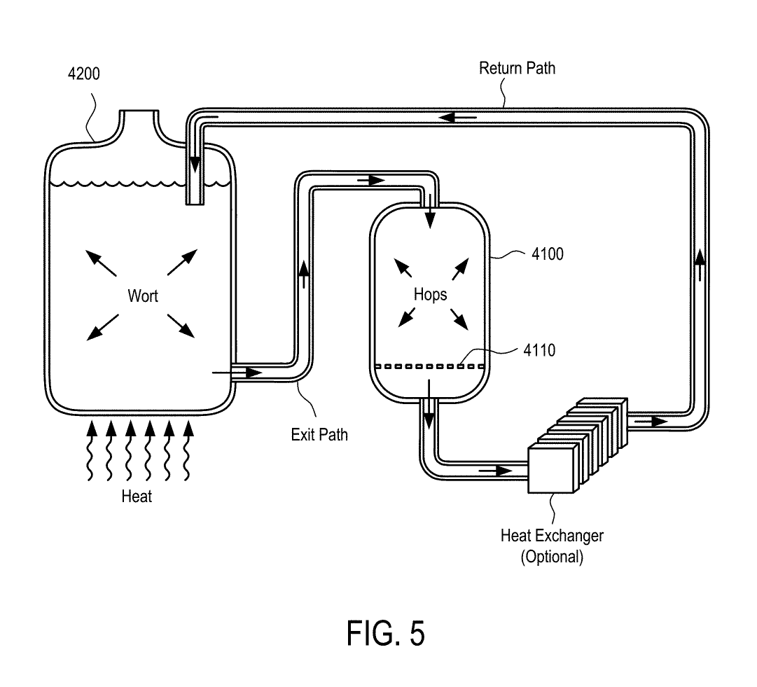

Second, in another embodiment for using traditional hops, a batch of very low brix wort is prepared with sufficient vegetative hops as to provide the bittering desired by the brewer. This wort is boiled sufficiently as to isomerize the bittering acids of the hops, and extract into the wort those compounds. The vegetative hops are then removed and the wort is evaporated to a level of concentration such that the volume is substantially reduced. This wort is intentionally made appropriately thin to accommodate for the concentrating effect caused by evaporation. This wort is added to the beer as yeast metabolism begins to slow during its final ferment, thus avoiding any processing through a membrane, and limiting the active yeasts exposure to becoming coated with hop resins during its final ferment. The process of utilizing vegetative hops in this way can also benefit from the configuration illustrated in FIGS. 4 and 5, whereby vegetative hops are added to an external tank fitted with a mesh screen to aid in filtering out vegetative material, and hot wort from the kettle is passed through the vegetative material (hops) loaded into the tank. This option is particularly beneficial when there is a very large quantity of vegetative hops needing to be processed relative to the amount of liquid (i.e. wort) being used for extraction and isomerization purposes. As shown in FIG. 5, depending on the temperature of the vegetative hops tank, an optional heat exchanger may be used to reduce the temperature of the return liquid to the kettle.

Turning to FIG. 4, it illustrates an embodiment of the present invention that allows the brewer to stage multiple hops additions without adding the hops directly to the kettle. For many beers, vegetative hops are added to the kettle boil multiple times during the boiling process. The time in which the hops are added, and hence the duration of time in which the hops are boiled affects the outcome and contribution those hops make to the finished beer. Hops added early in the boil contribute mostly “bittering” to the beer. Hops added near the end contribute more flavor and aroma, and hops added at the very end, typically add mostly aroma. While hops added at any time will contribute some of each of these elements, this can be taken as a “general rule of thumb”.

By way of example for explanation purposes only, for many beers a 60 minute boil is typical, and three separate hop additions at different intervals is not unusual (often times there are even more). In order to get the correct profile, bittering hops may be added at the very beginning of the boil, then flavoring hops after approximately 40 minutes of boiling, and then aroma hops just before the end of boiling (e.g., after 59 minutes of boiling for a 60 minute boil). Thus the three different hop additions impact the beer differently. Often times these additions are done with different strains of hops, because some hop varieties are better for bittering, and others are cultivated for their flavor and/or aroma qualities.

For brewing a high density beverage, one potential problem is that in the final wort addition (sometimes referred to as the nest) multiple beers worth of hops compounds (bittering, flavor, and aroma) are added. However, adding a large quantity of vegetative hops to the kettle can cause problems with the brewing equipment. In order to avoid this issue, FIG. 4 provides a system (and corresponding method) that provides for multiple stages of hop additions without adding the hops directly to the kettle. In particular, by having multiple hop tanks 4101-4103, with filter screens, the brewer can divert the boiling wort through any of the selected hop tanks at any specific time during the boil.

For example, in one embodiment of the present invention, bittering hops could be added to Tank 1 4101 flavoring hops to Tank 2 4102, aroma hops to Tank 3 4103, and a second volume of aroma hops to Tank 4 4104. The brewer begins diverting the boiling wort from the kettle 4200 through Tank 1 as soon as the wort begins to boil, and can continue to do so through a majority of (or the entire) boil. This effectively delivers the buttering compounds of interest. After the appropriate time period (e.g., 40 minutes if using the example from above) the brewer additionally diverts the boiling wort through Tank 2 4102, thus extracting the flavoring benefits of those hops into the wort. Near the end of the boiling (e.g., after 59 minutes of a 60 minute boil using the example from above), the brewer can also diverts the wort through hop Tank 3 4103, thus adding the aroma fraction of those hops. At the very end of the boil (e.g., 60 minutes in the example above), the heat can be turned off, and the wort (hot, but no longer boiling) diverted through hop Tank 4 4104, which adds even more hop aroma. As each subsequent tank is opened, the previous tanks may remain open as well. By staging these additions outside the kettle 4200 in this manner, the brewer can use very large quantities of vegetative hops without clogging up or causing production problems within the brew-house and heat exchanger equipment.

In some embodiments, it may also be advantageous to run a pressurized gas (e.g., nitrogen, carbon dioxide, or oxygen) through the system to “push” the liquid through the bottom screens of the tank, while leaving the vegetative hop material behind. This results in a better yield of hop-fortified wort.

It should be noted that the use of four external hop tanks is not required. Those of skill in the art will recognize many variations consistent with the present invention. For example, turning to FIG. 5, it provide another embodiment consistent with the present invention where a single external hop tank 4100 tied to the brewing kettle, and illustrates how the mesh screen 4110 is positioned to help hold back the vegetative hops, while allowing liquid to pass through. This single hop-tank configuration would be appropriate if only a single type of hops is used, or if all hops can be added to this external chamber at different time periods in accordance with the discussion above. Those of skill in the art will recognize that other numbers of external hop tanks would be consistent with the present invention.

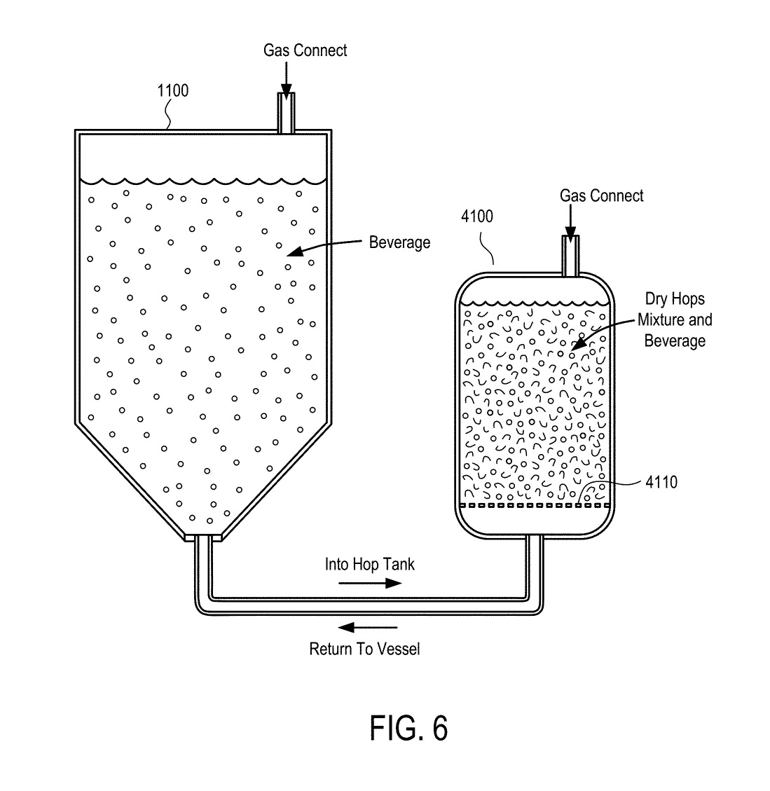

FIG. 6 illustrates the use of an external hop tank 4100 connected to a fermentation vessel 1100 (rather than a brewing kettle). In this configuration, the fermented beverage (or fermenting beverage) can be transferred into the hop tank 4100 to allow the beer to become “infused” with the flavor/aroma of the vegetative hops. This extraction takes place at fermentation temperatures or below (if the beer is in its cooling cycle). Once adequate extraction has taken place (often several days), the beer can be transferred back to the fermentation vessel 1100 to condition or undergo further fermentation or processing. If transferred via pressurized gas, only inert gas such as N₂ or CO₂ should be used, as the beverage at this stage is susceptible to oxidation.

The tank configuration in FIG. 6 can also be structured to create a loop with a feed into the hop tank, and a return from the tank into the fermenter. The advantage is that a very large volume of beer (the fermenter volume) can be gradually/slowly moved through the smaller hop tank over a period of time, thus optimizing the extraction of the desired hop compounds due to the large volume of extraction liquid that they are exposed to through this loop. In some embodiments, there is an additional mesh screen placed near the top of the inside of the hop tank, which allows the flow of beer traveling through the hop tank to feed into the bottom and out of the top of the hop tank.

Those of skill in the art will realize that the disclosed options are exemplary, and that there are many variations and modifications for using traditional hops that are consistent with the present invention.

Aroma Hops

In further embodiments, the present invention discloses improved methods for adding aroma hops to a nested fermentation process that includes membrane processing. In one embodiment, hop aroma extracts can be used as a substitute for the vegetative aroma hops. These compounds (typically oils, or solutions of hop oils) are prepared from specific varieties of hops, and therefore express the aroma profile of the source hops. In the preferred embodiment, the hop aroma extract product should be added to the final fermentation stage after all membrane processing has been conducted but before fermentation is complete. As discussed for the buttering hops, it is preferred that fermentation be in a slowing (conditioning) state, but not stopped, so that the yeast can consume any oxygen added when the hop aroma extract is added. In addition, the additional fermentation by the yeast will limit “coating” effects and promote more uniform dispersal of the hop aroma extract. It is also possible to add the hop aroma extracts post-fermentation if there are enough processing steps remaining to support adequate uniform blending and saturation of the hop aroma extracts within the beverage. For example, adding hop aroma extracts slowly during filtration/transfer of the beverage is a good alternative.

Although the quality of aroma extracts has progressed considerably over the years, and will continue to progress, some may prefer using traditional (vegetative) hops. In some embodiments, the present invention uses traditional vegetative hops by adding the hops in sufficient quantity to the final batch of wort so as to compensate for the full degree of the finished beverage's aroma and flavor density profile. When adding the traditional hops to the wort to fortify the aroma and/or flavor profile, the brewer may add the hops during the kettle boil (in the same timing and sequence as would typically be added for a beverage using a traditional approach). Aroma hops are typically added very late in the boil, and flavoring hops closer to the middle of the boil. Although this process does not eliminate exposure of the hop aroma/flavoring compounds to the membrane process, it limits any exposure to only the final process. If aroma hops and/or flavoring hops are to be added to a final wort preparation as described above, the efficiency of the membrane should be considered in determining the amount of hops to be used. If a membrane will result in observed reductions to hop profile, the amount of hops used when preparing the final wort should be adjusted accordingly to compensate for any membrane loss. FIGS. 4 and 5 show configurations ideal for adding large quantities of aroma hops (and/or bittering and flavoring hops) to the prepared wort being used in this step.

In yet a further embodiment of adding traditional vegetative aroma hops, a thin batch of wort may be prepared with aroma hops and then concentrated. Note that the concentration process for aroma hops should not use evaporation (e.g., freeze concentration or membrane concentration are possibilities), since evaporation supports the loss of the desired volatile hop aroma compounds. Once the final wort reaches a sufficient concentration of aroma hops, this aroma concentrated wort can then be added after final membrane processing of the beverage takes place, thereby avoiding any of the aroma compounds within the beverage from being processed through the membrane separation step.

Dry Hops

In a traditional process, raw vegetative hops may be added directly to the fermentation vessel (at different stages) to impart a fresh hoppy aroma to the beer. This is commonly called “dry hopping.” In a preferred embodiment of the present invention, the total amount of dry hops to be added should be done as the beer enters its final ferment after all membrane processing is complete. Because the dry hops are to be added to a beer that is already in a state of “high density” (having already undergone all prior nesting and concentration steps), the resulting quantity of hops relative to the volume of liquid can be assumed to be quite high. Thus a preferred configuration (illustrated in figure F), may be considered to better support the dry hopping process. Figure F shows an external tank with a false (mesh) bottom, which after being can be filled with the quantity of hops desired for dry hopping, adequately flushed with an inert gas (such as CO2 or N2), and where wort from the fermentation vessel can be transferred into and then out of the external tank once effective dry hopping has taken place. An inert gas such as N2 or CO2 can be used to aid in the transfer of this liquid both into and out of the external tank in order to protect against oxidation of the beer. This tank configuration can be further structured to create a loop with a liquid feed supply into the hop tank, and a return from the tank into the fermentation vessel. The advantage is that a very large volume of beer contained within a fermentation vessel can be gradually/slowly moved through the smaller hop tank over a period of time, thus optimizing the extraction of the desired hop compounds due to the large volume of extraction liquid that they are exposed to through this loop. In some embodiments, there is an additional mesh screen placed near the top of the inside of the hop tank, which allows the flow of beer traveling through the hop tank to feed into the bottom and out of the top of the hop tank.

Temperature Adjustments to Fermentation

Membrane processing results in some loss of yeast produced aroma through the permeate stream. This effect can be reduced by subsequent re-processing and recovery through additional (potentially more selective) membranes. However, this adds complexity and cost of equipment for the brewer. By fermenting at higher temperatures, the brewer can manipulate the yeasts aroma contribution to the beer, such that a greater abundance of aroma compounds are formed. Therefore, compensating for the loss that occurs through the membrane processing. However, it is understood by brewers that with increases of fermentation temperatures, changes in yeast metabolism can also induce negative effects to the flavor profile of the beer. Certain off-flavors (such as fusil alcohols, or disproportional ester production) are associated with beer that was fermented at too-warm of temperature. Thus, this tactic should be approached carefully to support increases in beneficial aroma production, and not a build-up of off-flavor compounds.

Supporting Lower Pressure Processing

Some fermented beverages, including beer, contain a great many compounds that add to the osmotic pressure barrier of the beverage relative to a specified membrane. Because of the substantial quantity of carbohydrates in some fermented beverages (such as beer) and wort, carbohydrates are a primary contributor to the liquid's osmotic pressure threshold. When nesting new wort into these beverages during simultaneous alcohol removal processing via membrane, the introduction of the new wort causes a sharp increase to the carbohydrate composition of the fermenting beverage. This increase in carbohydrates results in an increase to the osmotic pressure of the liquid. As higher operating pressures are required to efficiently remove permeate, the energy expense of operating at higher pressures, and the equipment costs of higher pressure systems becomes a relevant consideration. Thus in some cases it is desirable to have a method of reducing the necessary operating pressures to perform the nested exchange.

By running permeate removal more slowly, and introducing new wort at the same rate, the brewer can balance the nested exchange such that new wort is introduced at the rate by which the yeast are capable of fermenting the newly added fermentable sugars. As these sugars are metabolized, the carbohydrate composition of the fermenting beverage is reduced and therefore, the osmotic pressure of the liquid is kept at lower levels. The result is that the exchange takes longer, but can take place at lower membrane operating pressures.

Another option for reducing the operating pressures of the membrane process is to intentionally prepare the wort so that the finished beverage will be quite “dry”. This can be done by adding enzymes or supporting a higher conversion of starches and unfermentable and lower-fermentable sugars by regulating temperatures and holding times of the mash. By increasing the ratio of fermentable sugars, and allowing the yeast to convert a high percentage of those sugars prior to membrane processing, the beverage being processed through the membrane system will have a lower osmotic pressure, and can therefore be processed at lower pressures. The reduced density composition of the finished beer can be adjusted after the beer has undergone final membrane processing. The addition of maltodextrins to the beverage as it enters its final conditioning phase supports the fortification of those density adding ingredients without adding osmotic pressure to the beverage when it undergoes membrane processing. Adding the maltodextrins while some residual fermentation is taking place ensures that oxygen ingress caused by that addition is metabolized by the active yeast.

As an alternative to adding maltodextrin to build density into the finishing beverage, the final batch of wort which is to be nested can be prepared such that it provides a higher abundance of unfermentable sugars and starches. One way to do this is to increase the mash temperatures to support different enzyme activities that yield less conversion in the mash. Malts with high levels of maltodextrins can also be added to the mash to increase their abundance in the finished wort. While this process does not avoid the final processing through the membrane (and hence high osmotic pressures at that time), it defers the high osmotic pressure composition of the wort to the final processing through the membrane rather than through each earlier pass. Therefore the brewer benefits from lower osmotic processing up and until the final processing takes place.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method for building a high-density fermented beverage, the method comprising:
performing a fermentation process on fermentation ingredients to form a fermented solution in a fermentation vessel; and
removing alcohol, aromatics, and/or water from the fermented solution, wherein the removal comprises:
positioning a membrane intake in a region of lower yeast density the fermentation vessel;
removing a first portion of the fermented solution from the fermentation vessel using the membrane intake; and
removing alcohol, aromatics, and/or water from the first portion of the fermented solution.

2. The method of claim 1 wherein the removal further comprises:
separating alcohol, aromatics, and/or water from the first portion of the fermented solution thereby creating a retinate and a permeate;
positioning a retinate return in the fermentation vessel; and
returning at least a portion of the retinate to the fermentation vessel using the retinate return.

3. The method of claim 1 wherein the membrane intake is positioned below a top fermentation region for a top fermenting yeast.

4. The method of claim 3 wherein the membrane intake is positioned above a yeast settling region.

5. The method of claim 2 wherein the retinate return is positioned below a top fermentation region for a top fermenting yeast.

6. The method of claim 5 wherein the retinate return is positioned between the membrane intake and the top fermentation region.

7. The method of claim 5 wherein the retinate return is positioned below the membrane intake and above a yeast settling area.

8. The method of claim 1 wherein the removal further comprises:
performing a yeast removal process on the first portion of the fermented solution; and
performing a membrane process on the first portion of the fermented solution after the yeast removal process to separate out alcohol, aromatics, and/or water.

9. The method of claim 2 wherein positioning the retinate return in the fermentation vessel comprising positioning the retinate return in a position that reduces turbidity in the fermentation vessel.

10. A system for building a high-density fermented beverage, the system comprising:
a fermentation vessel;
a membrane system connected to the fermentation vessel;
a membrane intake that provides an input to the membrane system from the fermentation vessel, wherein the membrane intake is positioned in a region of lower yeast density; and
a retinate return that provides an input to the fermentation vessel from the membrane system.

11. The system of claim 10 wherein the membrane intake is positioned below a top fermentation region for a top fermenting yeast.

12. The system of claim 11 wherein the membrane intake is positioned above a yeast settling region.

13. The system of claim 11 wherein the retinate return is positioned below the top fermentation region.

14. The system of claim 13 wherein the retinate return is positioned between the membrane intake and the top fermentation region.

15-17. (canceled)

18. The system of claim 10 wherein the membrane intake is positioned above a bottom fermentation region for a bottom fermenting yeast.

19. The system of claim 10 wherein the retinate return is positioned above the membrane intake.

20. The system of claim 18 wherein the retinate return is positioned between the membrane intake and the bottom fermentation region.

21. The system of claim 10 wherein the membrane intake is adjustably positionable.

22. The system of claim 21 wherein the retinate return is adjustably positionable.

23. The system of claim 10 further comprising a yeast removal system connected between the fermentation vessel and the membrane system.

24-50. (canceled)
